(19) United States
(12) Patent Application Publication
(10) Pub. No.: US 2025/0271990 A1
(43) Pub. Date: Aug. 28, 2025

(54) METHOD AND APPARATUS FOR PRESENTING CONVERSATION INTERFACE, ELECTRONIC DEVICE, STORAGE MEDIUM AND PROGRAM PRODUCT

(71) Applicant: Beijing Zitiao Network Technology Co., Ltd., Beijing (CN)

(72) Inventors: Huimin Jiang, Beijing (CN); Yuxuan Zhao, Beijing (CN); Jiangong Mei, Beijing (CN)

(21) Appl. No.: 19/061,293

(22) Filed: Feb. 24, 2025

(30) Foreign Application Priority Data
Feb. 23, 2024 (CN) 202410205404.8

(51) Int. Cl. G06F 3/0486; G06F 3/0483

(52) U.S. Cl. CPC G06F 3/0486; G06F 3/0483; G06F 2203/04803

(57) ABSTRACT

Provided in the disclosure a method and apparatus for presenting a conversation interface, an electronic device, a storage medium and a program product. The method includes the steps of presenting, in response to a conversation interface presenting operation, a conversation interface between a first user and a second user; obtaining a page content corresponding to a virtual object, the virtual object associated with information of interaction behavior between the first user and the second user; and presenting the page content in the conversation interface.

CROSS-REFERENCE

This application claims priority to China patent application 202410205404.8, entitled “Method and Apparatus for Presenting Conversation Interface, Electronic Device, Storage Medium and Program Product” filed on Feb. 23, 2024, the entire contents of which are incorporated herein by reference.

### FIELD

The embodiment of the invention relates to a field of computer technology, and in particular, to a method and apparatus for presenting a conversation interface, an electronic device, a storage medium and a program product.

### BACKGROUND

Currently, in some applications, a user may view a conversation interface between the user and another user, however, content presented in the conversation interface is relatively homogenous.

### SUMMARY

The embodiments of the present disclosure provide a method and apparatus for presenting a conversation interface, an electronic device, a storage medium and a program product.

According to a first aspect, an embodiment of the present disclosure provides a method for presenting a conversation interface, including:

receiving a conversation interface presenting operation of a current user for a target user;

in response to the conversation interface presenting operation, presenting a conversation interface between the current user and the target user; and

presenting page content corresponding to a virtual object in the conversation interface, the virtual object associated with interaction behavior information between the current user and the target user.

According to a second aspect, an embodiment of the present disclosure further provides an apparatus for presenting a conversation interface, including:

an operation receiving module configured to receive a conversation interface presenting operation of a current user for a target user;

a conversation interface presenting module configured to show a conversation interface between the current user and the target user in response to the conversation interface presenting operation; and

a content presenting module configured to show page content corresponding to a virtual object in the conversation interface, the virtual object associated with interaction behavior information between the current user and the target user.

According to a third aspect, an embodiment of the present disclosure further provides an electronic device, including:

one or more processors;

a memory configured to store one or more computer programs,

when executed by the one or more processors, the one or more programs causes the one or more processors to implement the method for presenting a conversation interface according to the embodiments of the present disclosure.

According to a fourth aspect, an embodiment of the present disclosure further provides a computer readable storage medium having stored thereon a computer program that, when executed by a processor, implements the method for presenting a conversation interface according to an embodiment of the present disclosure.

According to a fifth aspect, an embodiment of the present disclosure further provides a computer program product, which, when executed by a computer, causes the computer to implement the method for presenting a conversation interface according to an embodiment of the present disclosure.

### BRIEF DESCRIPTION OF DRAWINGS

The above and other features, advantages, and aspects of embodiments of the present disclosure will become more apparent with reference to the following detailed description taken in conjunction with the accompanying drawings. Throughout the drawings, the same or similar reference numerals denote the same or similar elements. It should be understood that the drawings are schematic and that elements and elements are not necessarily drawn to scale.

FIG. 1 is a schematic flowchart of a method for presenting a conversation interface provided by an embodiment of the present disclosure;

FIG. 2 is a schematic diagram of presenting a conversation interface provided by an embodiment of the present disclosure;

FIG. 3 is a schematic diagram of presenting another conversation interface provided by an embodiment of the present disclosure;

FIG. 4 is a schematic flowchart of another method for presenting a conversation interface provided by an embodiment of the present disclosure;

FIG. 5 is a schematic diagram of presenting an object detail interface provided by an embodiment of the present disclosure;

FIG. 6 is a schematic diagram of presenting an achievement detail interface provided by an embodiment of the present disclosure;

FIG. 7 is a schematic diagram of a co-raise invitation process for a virtual object provided by an embodiment of the present disclosure;

FIG. 8 is a structural block diagram of an apparatus for presenting a conversation interface provided by an embodiment of the present disclosure;

FIG. 9 is a schematic structural diagram of an electronic device provided by an embodiment of the present disclosure.

### DETAILED DESCRIPTION

The following will describe the embodiments of the present disclosure in more detail with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, but are not used to limit the order or interdependence of the functions performed by these devices, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of the messages or information exchanged between a plurality of devices in the embodiment of the present disclosure are for illustrative purposes only and are not intended to limit the scope of these messages or information.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

It can be understood that data involved in this technical solution (including but not limited to the data itself, acquisition or use of the data) should comply with the requirements of corresponding laws, regulations and relevant provisions.

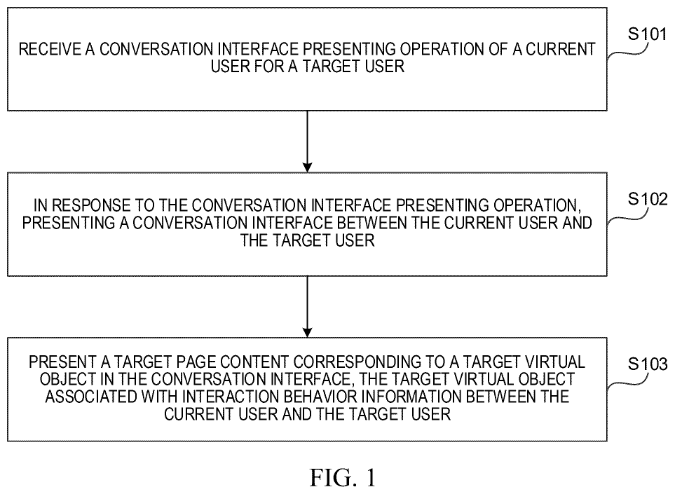

FIG. 1 is a schematic flowchart of a method for presenting a conversation interface provided by an embodiment of the present disclosure. The method may be performed by an apparatus for presenting a conversation interface, where the apparatus may be implemented by software and/or hardware, may be configured in an electronic device, and typically, may be configured in a mobile phone or a tablet computer. The method for presenting a conversation interface provided by the embodiment of the present disclosure is suitable for a scene of presenting page content related to a co-raised virtual object of both parties of a conversation in a conversation interface. As shown in FIG. 1, the method for presenting a conversation interface provided in this embodiment may include:

At S101, a conversation interface presenting operation of a current user for a target user is received.

The conversation interface presenting operation may be a triggering operation used to instruct to show a conversation interface between the current user and a user. An execution manner of the conversation interface presenting operation is not limited, for example, the conversation interface presenting operation may be an operation of triggering a conversation control corresponding to the target user, or an operation of performing a sliding gesture for instructing to show the conversation interface. The current user may be understood as a user performing a conversation interface presenting operation. The target user may be a user corresponding to the conversation interface presenting operation, for example, a user who has a conversation interface presented by the conversation interface presenting operation with the current user.

In this embodiment, when a current user wants to view a conversation interface between the current user and a certain user (for example, a target user), a conversation interface presenting operation for the user may be performed. Correspondingly, the current application may receive the conversation interface presenting operation performed by the current user.

S102: in response to the conversation interface presenting operation, a conversation interface between the current user and the target user is presented.

Specifically, when the conversation interface presenting operation of the current user for the target user is received, the conversation interface between the current user and the target user may be presented in response to the conversation interface presenting operation. The conversation interface may be understood as an interface used by the current user to have a conversation with the target user.

S103: page content corresponding to a virtual object is presented in the conversation interface, the virtual object associated with interaction behavior information between the current user and the target user.

The virtual object may be a virtual object that is co-raised by the current user and the target user. The virtual object may be, for example, a virtual animal and/or a virtual plant, and may be specifically set or selected as needed.

The virtual object is associated with the interaction behavior information between the current user and the target user. For example, the virtual object may be obtained and/or grown based on the interaction behavior information between the current user and the target user; or the virtual object may be associated with a certain associated object or a certain associated element of the interaction behavior information.

Optionally, the virtual object associated with first interaction behavior information between the current user and the target user includes: the virtual object having an association relationship with a preset relationship identifier of a preset interaction relationship between the current user and the target user, and the preset interaction relationship is built based on the interaction behavior information between the current user and the target user.

The preset interaction relationship between the current user and the target user may be an interaction relationship built based on the interaction behavior information between the current user and the target user. The interaction behavior information may include conversation behavior information, comment behavior information, and/or liking behavior information. The conversation behavior information may be understood as information about a conversation behavior between the current user and the target user; the comment behavior information may be understood as information about a comment behavior between the current user and the target user with respect to media content published by the other party; and the liking behavior information may be understood as information about a liking behavior between the current user and the target user with respect to media content published by the other party. In the following, for example, the interaction behavior information includes conversation behavior information, and at this time, the preset interaction relationship may be built based on the conversation behavior information between the current user and the target user. For example, the preset interaction relationship may be built after the conversation is performed between the current user and the target user for n consecutive days. The preset relationship identifier may be a relationship identifier of the preset interaction relationship.

In some implementations, the virtual object may have an association relationship with a preset relationship identifier of a preset interaction relationship between the current user and the target user, in other words, a virtual object co-raised between two users may be associated with the preset relationship identifier between the two users. Optionally, the virtual object having the association relationship with the preset relationship identifier of the preset interaction relationship between the current user and the target user includes at least one of the following: a growth value (which may also be referred to as growth attribute) of the virtual object associated with a presentation attribute of the preset relationship identifier; an object state of the virtual object associated with the preset relationship identifier; and display of an object identifier of the virtual object and display of the preset relationship identifier capable of switching to each other.

The growth value of the virtual object may be used to describe a growth degree of the virtual object. The growth value of the virtual object associated with the presentation attribute of the preset relationship identifier may be understood as that the growth value of the virtual object is associated with an attribute presented by the preset relationship identifier, for example, is associated with a relationship attribute of a preset interaction relationship presented by the preset relationship identifier, and/or is associated with a presentation attribute of the preset relationship identifier. For example, the growth value of the virtual object may be determined, based on the preset interaction relationship, by the relationship attribute presented by the preset relationship identifier and/or the presentation attribute of the preset relationship identifier. For example, the presentation attribute of the preset relationship identifier may be understood as a presenting attribute of the preset relationship identifier, for example, a presenting style and/or a presenting duration of the preset relationship identifier.

The object state of the virtual object may be understood as a state of the virtual object, for example, a presenting state of the target object. Optionally, the object state includes at least one of an object color, an object look, and an object action. The object color may be understood as a color presented by the virtual object; the object look may be understood as an look presented by the virtual object; and the object action may be understood as an action presented by the virtual object. The object state of the virtual object may be associated with the preset relationship identifier, for example, the virtual object may be presented in different object states based on different presentation attributes of the preset relationship identifier, for example, the virtual object is presented in different colors, the virtual object is controlled to present different looks, and/or the virtual object is controlled to perform different actions.

The object identifier of the virtual object may be understood as an identifier of the virtual object, and may be used to identify the virtual object. The display of the object identifier of the virtual object and the display of the preset relationship identifier can be switch to each other. For example, in some cases, the display of the preset relationship identifier may be switched to the display of the object identifier of the virtual object; and/or in some cases, the display of the object identifier of the virtual object may be switched to the display of the preset relationship identifier. Alternatively, the display of the preset relationship identifier and the display of the object identifier of the virtual object may be switched to each other periodically.

The page content may be understood as page content corresponding to the virtual object. The specific content of the page content is not limited, and optionally, the page content includes at least one of an object identifier of the virtual object, a page gadget corresponding to the virtual object, and a preset control corresponding to the virtual object. The page gadget corresponding to the virtual object may be understood as a page gadget associated with the virtual object, for example, a page gadget used to present an object picture of the virtual object. The preset control corresponding to the virtual object may be a control associated with the virtual object, and the preset control may be used to trigger execution of an event associated with the virtual object, for example, the preset control may be used as an entry of a co-raise invitation interface and/or an entry of an object detail interface of the virtual object. Co-raise may also be referred to as interaction cooperatively by a plurality of users, e.g., by the current user and the target user.

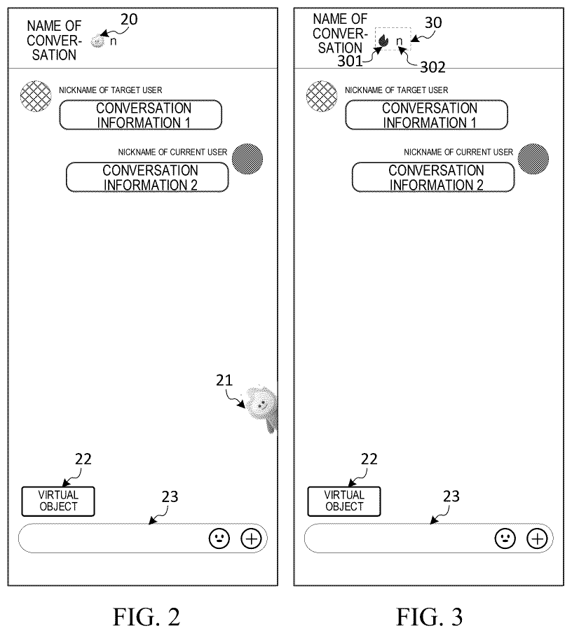

Specifically, when presenting the conversation interface between the current user and the target user, the page content corresponding to the virtual object associated with the interaction behavior information between the current user and the target user may be further presented in the conversation interface, for example, an object identifier 20 of the virtual object, a page gadget 21 corresponding to the virtual object, and/or the preset control 22 corresponding to the virtual object may be presented in the conversation interface between the current user and the target user, as shown in FIG. 2 and FIG. 3.

Therefore, by presenting, in a conversation interface of a conversation, page content corresponding to the virtual object associated with interaction behavior information between different users in the conversation, the content presented in the conversation interface and the presenting manner of the page content corresponding to the virtual object can be enriched, and the operations required for viewing the page content corresponding to the virtual object are simplified. In addition, virtual object growth can be obtained based on interaction behavior information between different users in the conversation, which enriches the obtaining of the virtual objects and growth modes of the virtual objects.

In some implementations, when the page content corresponding to the virtual object is presented in the conversation interface, a presenting position of the page content in the conversation interface may be flexibly set as needed, which is not limited in this embodiment.

For a case in which the page content includes the object identifier of the virtual object, the page gadget corresponding to the virtual object, and/or the preset control corresponding to the virtual object, for example, the object identifier of the virtual object may be presented in a top area of the conversation interface; the page gadget corresponding to the virtual object may be presented in a boundary area of the conversation interface; and/or the preset control corresponding to the virtual object may be presented in an area associated with the information input area of the conversation interface. In this case, optionally, the method for presenting a conversation interface further includes at least one of the following: presenting the object identifier in a top area of the conversation interface; presenting the page gadget in a boundary area of the conversation interface; and presenting the preset control in an area associated with an information input area of the conversation interface.

The top area of the conversation interface may be an area located at the top of the conversation interface, for example, an area associated with a conversation name presented at the top of the conversation interface. The boundary area of the conversation interface may be an area associated with one or more boundaries of the conversation interface, for example, an area within a first preset distance range from one or more boundaries of the conversation interface. For example, the boundary area of the conversation interface may be a side boundary area of the conversation interface, for example, an area within a first preset area range from a left boundary or a right boundary of the conversation interface. The area associated with the information input area may be an area within a second preset area range from the information input area, for example, a certain area located above, below, left, or right of the information input area.

Exemplarily, as shown in FIG. 2 and FIG. 3, the object identifier 20 of the virtual object may be presented after the conversation name of the conversation interface presented in the top area of the conversation interface, the page gadget 21 corresponding to the virtual object is presented in the left boundary area or the right boundary area of the conversation interface, and/or the preset control 22 corresponding to the virtual object is presented above the information input area 23.

In some implementations, the page gadget is presented in a boundary area of the conversation interface, and the method further includes, after presenting the page content corresponding to the virtual object in the conversation interface: in response to a dragging operation for the page gadget, controlling the page gadget to move with the dragging operation; and in response to a completion of the dragging operation, determining a target boundary area corresponding to a current position of the page gadget, and moving the page gadget to the target boundary area for presenting.

The dragging operation for the page gadget may be a triggering operation for dragging the page gadget to move in the conversation interface, such as, a triggering operation of pressing and moving the page gadget. The current position of the page gadget may be understood as a position to which the page gadget currently moves. The target boundary area may be a boundary area of the conversation interface corresponding to the current position of the page gadget. The way for determining the target boundary area is not limited, for example, the target boundary area may be a boundary area closest to the current position of the page gadget when the triggering of the dragging operation is complete, or a boundary area within a preset distance range from the current position of the page gadget. The following uses an example in which the target boundary area is a boundary area closest to the current position of the page gadget in the left boundary area and the right boundary area of the conversation interface for description.

In the foregoing implementation, the user may be supported to drag the page gadget corresponding to the virtual object in the conversation interface, to adjust a presenting position of the page gadget, so as to meet different presenting requirements of the user for the page gadget corresponding to the target object.

Specifically, when a dragging operation, presented in the conversation interface, for a page gadget corresponding to the virtual object is received, the page gadget may be controlled to move in the conversation interface with the dragging operation; and when it is detected that the triggering of the dragging operation ends, a target boundary area corresponding to the current position of the page gadget is determined, and the page gadget is moved to the target boundary area for presenting.

For example, the page gadget corresponding to the virtual object may be controlled to move with the dragging operation within the preset interface area of the conversation interface, and when it is detected that the triggering of the dragging operation ends, the current position of the page gadget is determined, whether the current position is located in the left boundary area or the right boundary area of the conversation interface is determined, and if yes, the page gadget may be presented in the left boundary area or right boundary area where the current position is currently located; and if not, a boundary area closest to the current position in the left boundary area and the right boundary area of the conversation interface may be determined, and the page gadget is moved to the boundary area for presenting.

The preset interface area may be an area in the conversation interface that supports dragging of the page gadget, and the preset interface area may be set as needed. For example, a left boundary of the conversation interface may be taken as a left boundary of the preset interface area, a right boundary of the conversation interface may be taken as a right boundary of the preset interface area, a lower boundary of a top area of the conversation interface may be taken as an upper boundary of the preset interface area, and/or an upper boundary, in an upper boundary of the information input area of the conversation interface and an upper boundary of a preset control, closer to the top area of the conversation interface may be taken as a lower boundary of the preset interface area, etc.

In some implementations, the page gadget is presented in a boundary area of the conversation interface, and the method further includes, after presenting the page content corresponding to the virtual object in the conversation interface: in response to preset page content additionally presented in the conversation interface, adjusting a presenting position of the page gadget in the boundary area based on a presenting position of the preset page content.

Preset page content may be page content additionally presented in the conversation interface, and for example, the preset page content may be page content of a set type that is additionally presented in the conversation interface, for example, a floating bar for presenting notification information or a virtual keyboard presented in response to a triggering operation on the information input area.

In the foregoing implementation, the presenting position of the page gadget corresponding to the virtual object in the boundary area may be adjusted based on the presenting position of the preset page content additionally presented in the conversation interface, to prevent the preset page content or the page gadget corresponding to the virtual object from blocking the other one.

Exemplarily, when there is preset page content to be additionally presented in the conversation interface, a presenting position of the preset page content in the conversation interface may be determined, the preset page content is presented at the presenting position. For a case in which the presenting position overlaps with a current presenting position of the page gadget in the conversation interface, the presenting position of the page gadget in the conversation interface is adjusted based on the above presenting position, for example, the presenting position of the page gadget in the boundary area is adjusted to one side along the boundary area where the page gadget is currently presented.

In some embodiments, the current user and the target user may obtain a co-raise achievement by the current user and the target user through co-raising a virtual object. After obtaining the co-raise achievement, a virtual item corresponding to the co-raise achievement may be further obtained, for example, a conversation tool corresponding to the co-raise achievement is obtained. In this case, optionally, the method for presenting a conversation interface further includes: in response to achieving second co-raise achievement for the virtual object, adding a conversation tool corresponding to the second co-raise achievement to a conversation tool interface of the current user, the conversation tool comprising at least one of a message display theme style, a conversation gadget, and a conversation emoji.

The second co-raise achievement may be understood as a co-raise achievement that is currently achieved by the current user and the target user through co-raising a virtual object, and an implementation manner of the combined maintenance may be preset, which is not limited in this embodiment. The conversation tool may be a tool for performing conversation, such as a message display theme style, a conversation gadget, and/or a conversation emoji. Herein, the message display theme style may include a message bubble style for presenting the transmitted conversation information; the conversation gadget may be presented at an associated position of the message bubble and/or the user identifier; and the conversation emoji may be used as information content of the conversation information for transmission.

The embodiments of the present disclosure provides a method and apparatus for presenting a conversation interface, an electronic device, a storage medium and a program product, including: receiving a conversation interface presenting operation of a current user for a target user; in response to the conversation interface presenting operation, presenting a conversation interface between the current user and the target user; and presenting page content corresponding to a virtual object in the conversation interface, the virtual object associated with interaction behavior information between the current user and the target user. In the present embodiments, with the technical solutions above, by presenting, in the conversation interface of the conversation, the page content corresponding to the virtual object associated with the interaction behavior information between different users in the conversation, the page content corresponding to the virtual object and the presenting style for the content presented in the conversation interface can be enriched, and the operations required for viewing the page content corresponding to the virtual object are simplified.

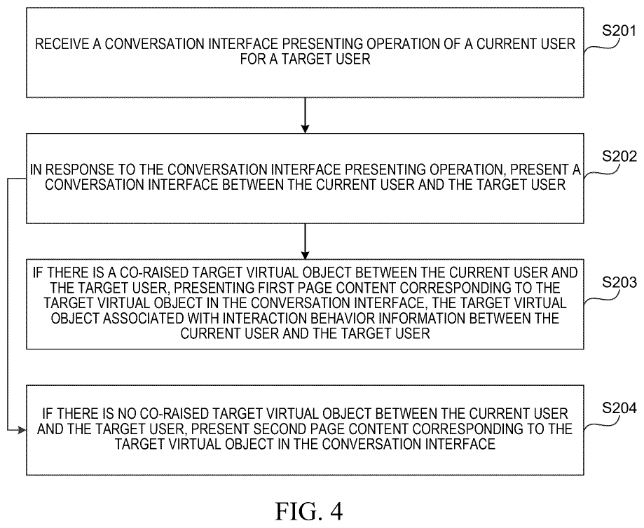

FIG. 4 is a schematic flowchart of another method for presenting a conversation interface provided by an embodiment of the present disclosure. The solution in this embodiment may be combined with one or more optional solutions in the foregoing embodiments. Optionally, presenting the page content corresponding to the virtual object in the conversation interface includes: in response that there is a co-raised virtual object between the current user and the target user, presenting first page content corresponding to the virtual object in the conversation interface; and/or in response that there is no co-raised virtual object between the current user and the target user, presenting second page content corresponding to the virtual object in the conversation interface.

Correspondingly, as shown in FIG. 4, the method for presenting a conversation interface provided by this embodiment may include:

At S201, a conversation interface presenting operation of a current user for a target user is received.

At S202, in response to the conversation interface presenting operation, a conversation interface between the current user and the target user is received, and then S203 or S204 is executed.

At S203, if there is a co-raised virtual object between the current user and the target user, first page content corresponding to the virtual object is presented in the conversation interface, and the virtual object is associated with the interaction behavior information between the current user and the target user.

The page content corresponding to the virtual object may include first page content. The first page content may be understood as page content that corresponds to the virtual object and that is presented when there is a co-raised virtual object between the current user and the target user. For example, the first page content may include at least one of an object identifier of the virtual object, a page gadget corresponding to the virtual object, and/or a preset control corresponding to the virtual object.

In the present embodiment, when there is a co-raised virtual object between the current user and the target user, the first page content corresponding to the virtual object may be presented, so that the current user can view related information of the co-raised virtual object.

Specifically, when the conversation interface presenting operation for the target user is received, in a case that there is a co-raised virtual object between the current user and the target user, in response to the conversation interface presenting operation, the conversation interface between the current user and the target user is presented, and the first page content corresponding to the virtual object is presented in the conversation interface, for example, the object identifier 20 of the virtual object, the page gadget 21 corresponding to the virtual object, and the preset control 22 corresponding to the virtual object are presented in the conversation interface, as shown in FIG. 2.

In some implementations, the first page content corresponding to the virtual object and presented in the conversation interface may support the user in triggering to view the object information of the virtual object. In this case, optionally, the method further includes, after presenting the first page content corresponding to the virtual object in the conversation interface: in response to an object detail presenting operation on the conversation interface, presenting an object detail interface of the virtual object, wherein, the object detail presenting operation comprises a triggering operation for the first page content.

The object detail presenting operation may be a triggering operation for instructing to show the object detail interface of the virtual object. The execution manner of the object detail presenting operation is not limited, for example, the object detail presenting operation may include but is not limited to a triggering operation for the first page content in the conversation interface, for example, the object detail presenting operation may further include an operation of performing a certain sliding gesture.

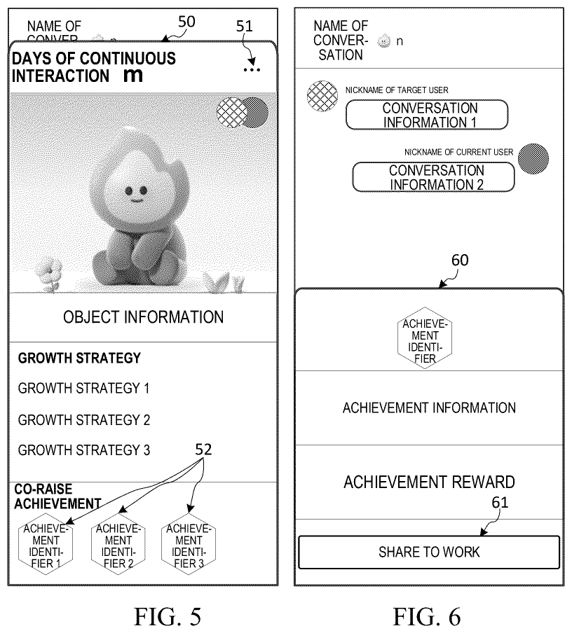

Specifically, when receiving the object detail presenting operation for the virtual object, for example, as shown in FIG. 2, when it is detected that the current user triggers the first page content presented in the conversation interface, for example, when it is detected that the current user triggers the object identifier 20 of the virtual object, the page gadget 21 corresponding to the virtual object, or the page control 22 corresponding to the virtual object that are presented in the conversation interface, the object detail interface 50 of the virtual object may be presented, for example, the object detail interface 50 of the virtual object is presented in a form of a panel in the conversation interface (as shown in FIG. 5) for the current user to view related information of the virtual object.

For example, as shown in FIG. 5, object information of the virtual object may be presented in the object detail interface of the virtual object, and the object information may include an object nickname, growth stage information, and/or a growth value of the virtual object. In addition, the object detail interface of the virtual object may further be displayed with interaction information, user identification information of the current user and the target user, an object picture of the virtual object, and/or a growth strategy of the virtual object. The interaction information may include, for example, an interaction duration, for example, consecutive interaction days, and the consecutive interaction days may be days of continuous interaction through the interaction behavior between the current user and the target user, or may be consecutive interaction days between the current user and the target user after the virtual object is built.

In some implementations, the user may be supported to modify the object information of the virtual object based on the object details interface of the target object and/or view the achievement details of the virtual object. In this case, optionally, the method further includes, after presenting the object detail interface of the virtual object: in response to an information modifying operation on the object detail interface, modifying object information of the virtual object; and/or, in response to an achievement detail presenting operation on the object detail interface, presenting an achievement detail interface for a first co-raise achievement, the first co-raise achievement obtained by co-raising a virtual object with the target user.

The information modifying operation may be a triggering operation used to instruct to modify the object information of the virtual object, for example, a triggering operation used to instruct to modify an object type and/or an object nickname of the virtual object. The execution manner of the information modification operation is not limited herein, for example, the information modifying operation may be an operation of triggering a control or performing a corresponding handheld triggering operation. The achievement detail presenting operation may be a triggering operation used to instruct to show an achievement detail interface for a certain co-raise achievement, for example, an operation of triggering an achievement identifier for a certain co-raise achievement, an achievement control, or an operation of performing a certain sliding gesture. Optionally, the object detail interface is presented with an achievement identifier for the first co-raise achievement, and the achievement identifier is configured to trigger the achievement detail presenting operation. The first co-raise achievement may be a co-raise achievement corresponding to the achievement presenting operation, that is, the achievement presenting operation is used to instruct to show a co-raise achievement of the achievement detail interface. The co-raise achievement may be understood as an achievement obtained by the current user by co-raising a virtual object with the target user, and the virtual object includes but is not limited to a currently co-raised virtual object.

Specifically, when receiving the information modifying operation on the object detail interface, the object information of the virtual object may be modified based on the information modifying operation; and/or, when the achievement detail presenting operation on the object detail interface is received, the achievement detail interface of the co-raise achievement (for example, the first co-raise achievement) corresponding to the achievement detail presenting operation may be displayed.

Taking modifying the object nickname of the virtual object as an example, as shown in FIG. 5, more controls 51 may be presented in the object detail interface 50 of the virtual object, and the more controls 51 may be used to trigger to show a nickname modification control. Therefore, when it is detected that the current user triggers the nickname modification control, it may be determined that an information modifying operation is received, and a nickname input area is presented in response to the information modifying operation, so that the current user inputs an object nickname to be modified; and when it is detected that the input operation of the current user is completed, the object nickname of the virtual object may be modified into the object nickname input by the current user in the nickname input area.

In addition, the user may also be supported to set whether to show the page gadget corresponding to the virtual object in the conversation interface, for example, when it is detected that the current user triggers the more controls in the object detail interface, a page gadget hiding/presenting control may be further presented, where the page gadget hiding/presenting control may be used to trigger hiding the page gadget corresponding to the virtual object and presented in the conversation interface, or trigger presenting the page gadget corresponding to the virtual object in the conversation interface. And/or, furthermore, the user may be supported to uncouple the co-raised virtual object, such as when detecting that the current user triggers more controls in the object detail interface, a uncoupling control of the virtual object may be further presented; thereby, upon detecting that the current user triggers the uncoupling control, the co-raised virtual object may be uncoupled, e.g., the co-raised virtual object may be deleted, and furthermore, the target user may be notified that the current user has uncoupled the virtual object.

With continued reference to FIG. 5, the object detail interface 50 of the virtual object may be presented with an achievement identifier 52 of at least one co-raise achievement obtained by the current user and the target user through co-raising the virtual object. Therefore, when it is detected that the current user triggers the achievement identifier 52 of a co-raise achievement, it may be determined that the achievement detail presenting operation corresponding to the co-raise achievement is received, and in response to the achievement detail presenting operation, the achievement detail interface 60 corresponding to the co-raise achievement is presented, and the achievement identifier, achievement information (such as achievement achieving conditions and/or achievement achieving time) and/or achievement reward (such as information of a virtual item corresponding to the co-raise achievement) of the co-raise achievement may be presented in the achievement detail interface 60, as shown in FIG. 6.

In some embodiments, the user may also be supported to create media content based on the obtained co-raise achievement, to enrich the creation manner of the media content and reduce the creation difficulty of the media content. In this case, optionally, the method further includes, after presenting the achievement detail interface for the first co-raise achievement: in response to a media content generating operation within the achievement detail interface, generating media content associated with the first co-raise achievement.

The media content generating operation may be a triggering operation used to instruct to generate media content, for example, an operation of triggering a work generation control in the achievement detail interface.

Exemplarily, when a media content generating operation on the achievement detail interface content is received, the media content may be generated based on the first s co-raise achievement. For example, in a case where it is detected that the current user triggers the media content generation control 61 (as shown in FIG. 6) in the achievement detail interface, the media content may be generated by taking the achievement screen of the first co-raise achievement as the media content screen.

In addition, after the media content is generated, the generated media content may be further stored, or the media content may be published, which may be specifically set as needed.

S204, if there is no co-raised virtual object between the current user and the target user, second page content corresponding to the virtual object is presented in the conversation interface.

The page content corresponding to the virtual object may include the second page content. The second page content may be understood as page content that corresponds to the virtual object and that is presented when there is no co-raised virtual object between the current user and the target user. For example, the second page content may include a preset control corresponding to the virtual object.

In this embodiment, when there is no co-raised virtual object between the current user and the target user, the second page content corresponding to the virtual object may be presented, so that the current user invites the target user to co-raise the virtual object.

Specifically, when a conversation interface presenting operation for the target user is received, in a case that there is no co-raised virtual object between the current user and the target user, a conversation interface between the current user and the target user may be presented in response to the conversation interface presenting operation, and the second page content corresponding to the virtual object is presented in the conversation interface, for example, a preset control 22 corresponding to the virtual object is presented in the conversation interface, as shown in FIG. 3.

In some implementations, the virtual object may not have an association relationship with the preset interaction relationship between the current user and the target user, and in this case, whether a preset interaction relationship exists between the current user and the target user may not be considered, and the second page content is directly presented in the conversation interface, to meet the co-raise requirement of the user.

In some other implementations, the virtual object may have an association relationship with the preset interaction relationship between the current user and the target user, for example, the virtual object may have an association relationship with the preset relationship identifier of the preset interaction relationship. In this case, whether a preset interaction relationship exists between the current user and the target user may be considered, and only when the preset interaction relationship exists between the current user and the target user, the virtual object is supported to be co-raised between the current user and the target user; and when t a preset interaction relationship does not exist between the current user and the target user, the virtual object is not supported to be co-raised between the current user and the target user. Therefore, only when a preset interaction relationship exists between the current user and the target user, the second page content corresponding to the virtual object is displayed in the conversation interface between the current user and the target user. In this case, optionally, presenting, in response that there is no co-raised virtual object between the current user and the target user, the second page content corresponding to the virtual object in the conversation interface includes: in response that there is no co-raised virtual object between the current user and the target user and there is a preset interaction relationship between the current user and the target user, presenting the second page content corresponding to the virtual object in the conversation interface.

In addition, when there is no co-raised virtual object between the current user and the target user and there is a preset interaction relationship between the current user and the target user, a first notification card may be further presented in the conversation interface, and the current user and the target user may be prompted that they can co-raise a virtual object by using the first notification card. An invitation interface control may be further presented in the first notification card, and the invitation interface control may be configured to trigger to perform a co-raise invitation operation to show a co-raise invitation interface.

In some implementations, the method further includes, after presenting the second page content corresponding to the virtual object in the conversation interface: in response to a co-raise invitation operation in the conversation interface, presenting a co-raise invitation interface, the co-raise invitation interface configured to set object information of a virtual object to be co-raised; and in response to a confirmation operation on the co-raise invitation interface, transmitting, in the conversation interface, co-raise invitation information for the virtual object in a form of conversation information, where the co-raise invitation information supports accepting co-raise invitation for the virtual object by triggering.

The co-raise invitation operation may be a triggering operation used to instruct to show a co-raise invitation interface. For example, the co-raise invitation operation may include an operation of triggering a certain control presented in the conversation interface or an operation of performing a certain triggering gesture in the conversation interface. Optionally, the co-raise invitation operation includes a triggering operation for the second page content. For example, the user may perform a co-raise invitation operation by triggering the second page content presented in the conversation interface. The confirmation operation on the co-raise invitation interface may be a triggering operation for instructing to transmit co-raise invitation information, for example, a triggering operation for triggering an invitation control in the co-raise invitation interface. The co-raise invitation information may be used to invite the target user to co-raise the virtual object, and may support a recipient (for example, the target user) of the co-raise invitation information triggering acceptance of the co-raise invitation for the virtual object.

In the foregoing implementation, the user may be supported to invite, based on the conversation interface, another user in a conversation corresponding to the conversation interface to co-raise the virtual object, so as to further enrich functions of the conversation interface.

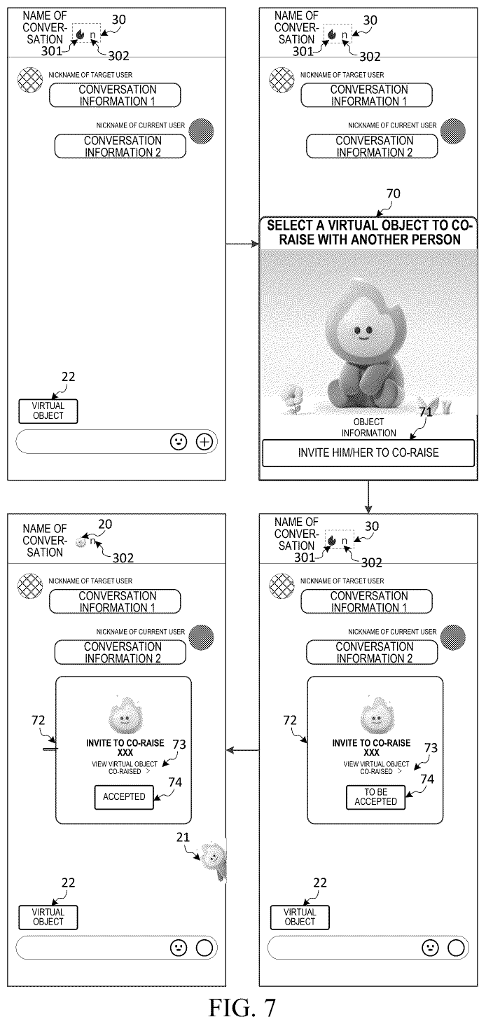

Specifically, in a case of receiving a co-raise invitation operation on the conversation interface, for example, in a case of detecting that the current user triggers the preset control 22 (as shown in the first figure in FIG. 7) presented on the conversation interface, a co-raise invitation interface 70 may be presented, as shown in the second figure in FIG. 7, so that the current user sets object information of a virtual object to be co-raised, for example, selecting an object type of the virtual object and/or inputting an object nickname of the virtual object. In a case of receiving a confirmation operation on the conversation interface, such as, in a case of detecting that the current user triggers the invitation control 71 in the co-raise invitation interface 70, co-raise invitation information 72 for the virtual object is transmitted in the conversation interface in a form of conversation information, as shown in the third figure in FIG. 7, to invite the target user to co-raise the virtual object. Herein, the manner of selecting the object type of the virtual object is not limited, for example, the object type of the virtual object may be switched by sliding in a preset direction (such as horizontal or vertical) or by triggering a switching control.

Still referring to the third figure in FIG. 7, at least part of object information of the virtual object may be presented in the co-raise invitation information, such as an object picture of the virtual object, an object type and/or an object nickname of the virtual object; or a viewing control 73 may be presented, and when the target user has not accepted the co-raise invitation, the viewing control 73 may be triggered to view a co-raise invitation panel; or when the target user has accepted the co-raise invitation, the viewing control 73 may be triggered to perform an object detail presenting operation for the virtual object.

In addition, for the co-raise invitation information 72, at the inviting side (for example, the current user side), status information 74 of the co-raise invitation may be presented in the co-raise invitation information 72, and the status information 74 may be used to indicate whether the target user has accepted the invitation, as shown in FIG. 7; and at the invited side (for example, the target user side), an acceptance control may be displayed in the co-raise invitation information 72, and the acceptance control may be triggered to accept the co-raise invitation for the virtual object.

For the invitation panel, after transmitting the co-raise invitation information, at the inviting side, a cancellation invitation control may be presented in the invitation panel, and the cancellation invitation control may be triggered to cancel the co-raise invitation for the virtual object; and at the receiving side, an acceptance control may be presented in the invitation panel, and the acceptance control may be triggered to accept the co-raise invitation for the virtual object.

In some implementations, the method further includes, after presenting the second page content corresponding to the virtual object in the conversation interface: in response to the target user or the current user accepting co-raise invitation for the virtual object, creating a target virtual image, and switching presenting of the second page content to presenting of the first page content, an initial growth value of the target virtual image is determined based on a presenting duration of a preset relationship identifier between the current user and the target user.

The initial growth value of the target virtual image may be understood as a growth value of a target virtual image when creating the target virtual image. The initial growth value of the target virtual image may be determined based on a presenting duration of the preset relationship identifier between the current user and the target user when the creating the target virtual image. Thus, when the presenting durations of preset relationship identifiers are different, the target virtual images corresponding thereto may have different initial growth values. For example, the presenting duration of a preset relationship identifier may be a duration during which the preset relationship identifier is presented on the conversation interface, for example, the number of days presenting the preset relationship identifier. In some implementations, immediately after the preset interaction relationship is built between the current user and the target user, the preset relationship identifier of the preset interaction relationship may be presented in the conversation interface between the current user and the target user.

Specifically, in a case that the target user accepts the co-raise invitation of the current user for the target virtual image, or in a case that the current user accepts the co-raise invitation of the target user for the virtual object, the target virtual image may be created by triggering, for example, the target virtual image may be created by an application at the current user side (that is, the current application), an application at the target user side, or a server, and the initial growth value of the target virtual image is determined based on the presenting duration of the preset relationship identifier between the current user and the target user.

In the foregoing implementation, the presenting of the second page content presented in the conversation interface may be switched to the presenting of the first page content. For example, as shown in FIG. 7 (taking an example in which the current user invites the target user to co-raise the virtual object as an example), when the co-raise invitation has not been accepted, a preset control 22 corresponding to the virtual object may be presented in the conversation interface; and after the co-raise invitation is accepted, an object identifier 20 of the virtual object and/or a page gadget 21 corresponding to the virtual object may be additionally presented in the conversation interface.

In the foregoing implementation, a manner for additionally presenting the object identifier 20 for of the virtual object in the conversation interface is not limited.

For example, as shown in FIG. 3 and FIG. 7, a preset relationship identifier 30 is presented in the conversation interface before the co-raise invitation is accepted, such as, a relationship icon 301 for a preset interaction relationship and a presenting duration 302 of the preset relationship identifier are presented.

In some implementations, after accepting the co-raise invitation, the presented preset relationship identifier 30 may be kept unchanged, and the object identifier 20 of the virtual object is additionally presented in the conversation interface.

In some other implementations, after accepting the co-raise invitation, presenting of the preset relationship identifier 30 presented in the conversation interface may also be switched to presenting of the object identifier 20 of the virtual object. For example, presenting of at least part of content of the preset relationship identifier 30 (e.g., the relationship identifier 30) can be switched to presenting of the object identifier 20 of the virtual object, as shown in FIG. 7. At this point, optionally, the first page content includes the object identifier 20 of the virtual object, and switching presenting of the second page content to presenting of the first page content includes: switching the preset relationship identifier 30 presented in the conversation interface to the object identifier 20 of the virtual object.

In the foregoing implementation, a presenting style for the object identifier switched to may be preset. Alternatively, the presenting color of the object identifier of the virtual object may be determined based on the presenting style for the preset relationship identifier and/or the initial growth value of the virtual object, such as, based on the presenting style (for example, the presenting color) of the object identifier of the virtual object of the preset relationship identifier; and/or, the growth stage of the virtual object is determined based on the initial growth value of the virtual object, and the object identifier of the virtual object is presented as a growth style corresponding to the growth stage. In this case, optionally, the presenting style for the object identifier switched to is associated with the presenting style for the preset relationship identifier and/or the initial growth value.

In addition, after the current user or the target user accepts the co-raise invitation, a second notification card may be presented in the conversation interface, and the current user or the target user may be notified through the second notification card that himself/herself or the other one has accepted the co-raise invitation. Here, a viewing control may be presented in the second notification card, and the viewing control may be triggered to show an invitation panel and/or an object detail interface of the virtual object. After the virtual object is grown up by raising, for example, when the virtual object reaches the highest level, a third notification card may be presented in the conversation interface, and the current user and the target user are prompted through the third notification card that the co-raise for the virtual object is completed, and a set virtual item, such as, a set conversation tool, may be transmitted to the current user and the target user through the server.

According to the method for presenting a conversation interface provided in this embodiment, different page content corresponding to the virtual object is displayed in the conversation interface between the current user and the target user based on whether there is a co-raised virtual object between the current user and the target user, so that diversity of page content corresponding to the virtual object and presented in the conversation interface can be improved, and object information of the virtual object viewed by the current user and/or operations required for inviting the target user to co-raise the virtual object are simplified.

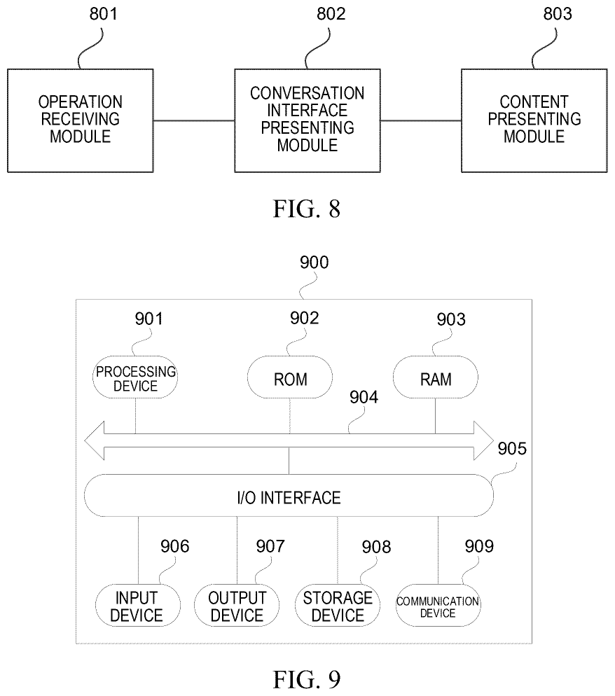

FIG. 8 is a structural block diagram of an apparatus for presenting a conversation interface provided by an embodiment of the present disclosure. The apparatus may be implemented by software and/or hardware, and may be configured in an electronic device, and typically, the apparatus may be configured in a mobile phone or a tablet computer, and may show page content related to a virtual object co-raised by both parties in a conversation interface by performing the method for presenting a conversation interface. As shown in FIG. 8, the apparatus for presenting a conversation interface provided in this embodiment may include: an operation receiving module 801, a conversation interface presenting module 802 and a content presenting module 803.

The operation receiving module 801 is configured to receive a conversation interface presenting operation of a current user for a target user.

The conversation interface presenting module 802 is configured to show a conversation interface between the current user and the target user in response to the conversation interface presenting operation.

The content presenting module 803 is configured to show page content corresponding to a virtual object in the conversation interface, the virtual object associated with interaction behavior information between the current user and the target user.

According to the apparatus for presenting a conversation interface provided in this embodiment, a conversation interface presenting operation of a current user for a target user is received by the operation receiving module; a conversation interface between the current user and the target user is presented by the conversation interface presenting module in response to the conversation interface presenting operation; and page content corresponding to a virtual object is presented in the conversation interface by using a content presenting module, where the virtual object is associated with interaction behavior information between the current user and the target user. In this embodiment, with the above technical solutions, by presenting, in a conversation interface of a conversation, page content corresponding to a virtual object associated with interaction behavior information between different users in the conversation, content presented in the conversation interface and a presenting manner of the page content corresponding to the virtual object can be enriched, thereby operations required for viewing the page content corresponding to the virtual object are simplified.

Optionally, the virtual object associated with first interaction behavior information between the current user and the target user includes: the virtual object having an association relationship with a preset relationship identifier of a preset interaction relationship between the current user and the target user, and the preset interaction relationship built based on the interaction behavior information between the current user and the target user.

Optionally, the virtual object having the association relationship with the preset relationship identifier of the preset interaction relationship between the current user and the target user includes at least one of the following: a growth value of the virtual object associated with a presentation attribute of the preset relationship identifier; an object state of the virtual object associated with the preset relationship identifier; and display of an object identifier of the virtual object and display of the preset relationship identifier capable of switching to each other.

Optionally, the object state includes at least one of an object color, an object look, and an object action.

Optionally, the page content includes at least one of an object identifier of the virtual object, a page gadget corresponding to the virtual object, and a preset control corresponding to the virtual object.

Optionally, the method further includes at least one of the following: presenting the object identifier in a top area of the conversation interface; presenting the page gadget in a boundary area of the conversation interface; presenting the preset control in an area associated with an information input area of the conversation interface.

Optionally, the page gadget is presented in a boundary area of the conversation interface, and the apparatus for presenting a conversation interface may further include: a movement controlling module configured to control, after presenting the page content corresponding to the virtual object in the conversation interface and in response to a dragging operation on the page gadget, the page gadget to move with the dragging operation; and a gadget presenting module configured to determine, in response to a completion of the dragging operation, a target boundary area corresponding to a current position of the page gadget, and moving the page gadget to the target boundary area for presenting.

Optionally, the page gadget is presented in a boundary area of the conversation interface, and the apparatus for presenting a conversation interface may further include: a position adjusting module configured to adjust, after presenting the page content corresponding to the virtual object in the conversation interface and in response to preset page content additionally presented in the conversation interface, a presenting position of the page gadget in the boundary area based on a presenting position of the preset page content.

Optionally, the content presenting module 803 may include: a first content presenting unit configured to show first page content corresponding to the virtual object in the conversation interface, in response that there is a co-raised virtual object between the current user and the target user; and/or a second content presenting unit configured to show second page content corresponding to the virtual object in the conversation interface, in response that there is no co-raised virtual object between the current user and the target user.

Further, the apparatus for presenting a conversation interface may further include: an object detail interface presenting module configured to show, after presenting the first page content corresponding to the virtual object in the conversation interface object detail interface of the virtual object and in response to an object detail presenting operation on the conversation interface, where the object detail presenting operation includes a triggering operation for the first page content.

Further, the apparatus for presenting a conversation interface may further include: an information modifying module configured to modify, after presenting the object detail interface of the virtual object and in response to an information modifying operation on the object detail interface, object information of the virtual object; and/or an achievement detail interface presenting module configured to show, after presenting the object detail interface of the virtual object and in response to, an achievement detail interface for a first co-raise achievement, the first co-raise achievement obtained by co-raising a virtual object with the target user.

Optionally, the object detail interface is presented with an achievement identifier for the first co-raise achievement, and the achievement identifier is configured to trigger the achievement detail presenting operation.

Further, the apparatus for presenting a conversation interface may further include: a media content generating module configured to generate, after presenting the achievement detail interface for the first co-raise achievement and in response to a media content generating operation within the achievement detail interface, media content associated with the first co-raise achievement.

Optionally, the second content presenting unit is configured to: show, in response that there is no co-raised virtual object between the current user and the target user and there is a preset interaction relationship between the current user and the target user, the second page content corresponding to the virtual object in the conversation interface.

Further, the apparatus for presenting a conversation interface may further include: a co-raise invitation interface presenting module configured to show a co-raise invitation interface in response to a co-raise invitation operation on the conversation interface and after presenting the second page content corresponding to the virtual object in the conversation, the co-raise invitation interface configured to set object information of a virtual object to be co-raised; and an information transmitting module configured to transmit, in the conversation interface, co-raise invitation information for the virtual object in a form of conversation information, in response to a confirmation operation on the co-raise invitation interface, the co-raise invitation information supporting triggering acceptance of the co-raise invitation for the virtual object.

Optionally, the co-raise invitation operation includes a triggering operation for the second page content.

Further, the apparatus for presenting a conversation interface may further include: a content switching module configured to: create, after presenting the second page content corresponding to the virtual object in the conversation interface and in response to the target user or the current user accepting co-raise invitation for the virtual object, a target virtual image, and switch presenting of the second page content to presenting of the first page content, an initial growth value of the target virtual image is determined based on a presenting duration of a preset relationship identifier between the current user and the target user.

Optionally, the first page content includes an object identifier of the virtual object, and the content switching module is configured to switch the preset relationship identifier presented in the conversation interface to an object identifier of the virtual object.

Optionally, a presenting style for the object identifier switched to is associated with a presenting style for the preset relationship identifier and/or the initial growth value.

Further, the apparatus for presenting a conversation interface may further include: a conversation tool presenting module configured to add, in response to achieving second co-raise achievement for the virtual object, a conversation tool corresponding to the second co-raise achievement to a conversation tool interface of the current user, the conversation tool including at least one of a message display theme style, a conversation gadget, and a conversation emoji.

The apparatus for presenting a conversation interface provided by the embodiment of the present disclosure may execute the method for presenting a conversation interface provided by any embodiment of the present disclosure, which has corresponding functional modules and beneficial effects for executing the method for presenting a conversation interface. For technical details not described in detail in this embodiment, the method for presenting a conversation interface provided in any embodiment of the present disclosure may be referred to.

Referring to FIG. 9 below, it is a structural schematic diagram of an electronic device 900 (such as the terminal device in the drawing) suitable for implementing the embodiment of the present disclosure. The terminal device in the embodiment of the present disclosure may include but is not limited to mobile terminals such as mobile phones, laptops, digital broadcast receivers, PDAs (Personal Digital Assistants), PADs (tablet computers), PMPs (portable multimedia players), car-mounted terminals (such as car navigation terminals), etc. and fixed terminals such as digital televisions (TV), desktop computers, etc. The electronic device shown in FIG. 9 is only an example and should not bring any limitation on the functionality and scope of use of the embodiment of the present disclosure.

As shown in FIG. 9, the electronic device 900 may include a processing device (such as a central processing unit, graphics processing unit, etc.) 901, which may perform various appropriate actions and processes based on programs stored in Read-Only Memory (ROM) 902 or loaded from storage device 908 into Random Access Memory (RAM) 903. In the RAM 903, various programs and data necessary for the operation of the electronic device 900 are also stored. The processing device 901, ROM 902, and RAM 903 are connected to each other through a bus 504. An Input/Output I/O interface 905 is also connected to the bus 904.

Typically, the following devices can be connected to I/O interface 905: input devices 906 including, for example, touch screens, touchpads, keyboards, mice, cameras, microphones, accelerometers, gyroscopes, etc.; output devices 907 including liquid crystal displays (LCDs), speakers, vibrators, etc.; storage devices 908 including magnetic tapes, hard disks, etc.; and a communication device 909. The communication device 909 may allow the electronic device 900 to communicate with other devices wirelessly or wirelessly to exchange data. Although FIG. 9 shows an electronic device 900 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 909, or installed from the storage device 908, or installed from the ROM 902. When the computer program is executed by the processing device 901, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

In some embodiments, clients and servers can communicate using any currently known or future developed network protocol such as HTTP (HyperText Transfer Protocol), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device receive a conversation interface presenting operation of a current user for a target user; show a conversation interface between the current user and the target user in response to the conversation interface presenting operation; and show page content corresponding to a virtual object in the conversation interface, the virtual object associated with interaction behavior information between the current user and the target user.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, Example 1 provides a method for presenting a conversation interface, including:

receiving a conversation interface presenting operation of a current user for a target user;

in response to the conversation interface presenting operation, presenting a conversation interface between the current user and the target user; and

presenting page content corresponding to a virtual object in the conversation interface, the virtual object associated with interaction behavior information between the current user and the target user.

According to one or more embodiments of the present disclosure, in the method of the example 2 according to example 1, the virtual object associated with first interaction behavior information between the current user and the target user including:

the virtual object having an association relationship with a preset relationship identifier of a preset interaction relationship between the current user and the target user, and the preset interaction relationship built based on the interaction behavior information between the current user and the target user.

According to one or more embodiments of the present disclosure, in the method of example 3 according to example 1, the virtual object having the association relationship with the preset relationship identifier of the preset interaction relationship between the current user and the target user comprising at least one of the following:

a growth value of the virtual object associated with a presentation attribute of the preset relationship identifier;

an object state of the virtual object associated with the preset relationship identifier;

display of an object identifier of the virtual object and display of the preset relationship identifier capable of switching to each other.

According to one or more embodiments of the present disclosure, in the method of example 4 according to example 3, the object state includes at least one of an object color, an object look, and an object action.

According to one or more embodiments of the present disclosure, in the method of example 5 according to example 1, the page content comprises at least one of an object identifier of the virtual object, a page gadget corresponding to the virtual object, and a preset control corresponding to the virtual object.

According to one or more embodiments of the present disclosure, the method of example 6 according to example 5 includes at least one of the following:

presenting the object identifier in a top area of the conversation interface;

presenting the page gadget in a boundary area of the conversation interface;

presenting the preset control in an area associated with an information input area of the conversation interface.

According to one or more embodiments of the present disclosure, in the method of example 7 according to example 5, the page gadget is presented in a boundary area of the conversation interface, and the method further includes, after presenting the page content corresponding to the virtual object in the conversation interface:

in response to a dragging operation for the page gadget, controlling the page gadget to move with the dragging operation;

in response to a completion the dragging operation, determining a target boundary area corresponding to a current position of the page gadget, and moving the page gadget to the target boundary area for presenting.

According to one or more embodiments of the present disclosure, in the method of example 8 according to example 5, the page gadget is presented in a boundary area of the conversation interface, and the method further includes, after presenting the page content corresponding to the virtual object in the conversation interface:

in response to preset page content additionally presented in the conversation interface, adjusting a presenting position of the page gadget in the boundary area based on a presenting position of the preset page content.

According to one or more embodiments of the present disclosure, in the method of example 9 according to any one of examples 1-8, presenting the page content corresponding to the virtual object in the conversation interface includes:

in response that there is a co-raised virtual object between the current user and the target user, presenting first page content corresponding to the virtual object in the conversation interface; and/or

in response that there is no co-raised virtual object between the current user and the target user, presenting second page content corresponding to the virtual object in the conversation interface.

According to one or more embodiments of the present disclosure, in the method of example 10 according to example 9, the method further includes, after presenting the first page content corresponding to the virtual object in the conversation interface:

in response to an object detail presenting operation on the conversation interface, presenting an object detail interface of the virtual object, wherein, the object detail presenting operation comprises a triggering operation for the first page content.

According to one or more embodiments of the present disclosure, in the method of example 11 according to example 10, the method further includes, after presenting the object detail interface of the virtual object:

in response to an information modifying operation on the object detail interface, modifying object information of the virtual object; and/or

in response to an achievement detail presenting operation on the object detail interface, presenting an achievement detail interface for a first co-raise achievement, the first co-raise achievement obtained by co-raising a virtual object with the target user.

According to one or more embodiments of the present disclosure, in the method of example 12 according to example 11, the object detail interface is presented with an achievement identifier for the first co-raise achievement, and the achievement identifier is configured to trigger the achievement detail presenting operation.

According to one or more embodiments of the present disclosure, in the method of example 13 according to example 11, the method further includes, after presenting the achievement detail interface for the first co-raise achievement:

in response to a media content generating operation within the achievement detail interface, generating media content associated with the first co-raise achievement.

According to one or more embodiments of the present disclosure, in the method of example 14 according to example 9, presenting, in response that there is no co-raised virtual object between the current user and the target user, the second page content corresponding to the virtual object in the conversation interface includes:

in response that there is no co-raised virtual object between the current user and the target user and there is a preset interaction relationship between the current user and the target user, presenting the second page content corresponding to the virtual object in the conversation interface.

According to one or more embodiments of the present disclosure, in the method of example 15 according to example 9, the method further includes, after presenting the second page content corresponding to the virtual object in the conversation interface:

in response to a co-raise invitation operation in the conversation interface, presenting a co-raise invitation interface, the co-raise invitation interface configured to set object information of a virtual object to be co-raised; and

in response to a confirmation operation on the co-raise invitation interface, transmitting, in the conversation interface, co-raise invitation information for the virtual object in a form of conversation information, the co-raise invitation information supporting triggering acceptance of the co-raise invitation for the virtual object.

According to one or more embodiments of the present disclosure, in the method of example 16 according to example 15, the co-raise invitation operation includes a triggering operation for the second page content.

According to one or more embodiments of the present disclosure, in the method of example 17 according to example 9, the method further includes, after presenting the second page content corresponding to the virtual object in the conversation interface:

in response to the target user or the current user accepting co-raise invitation for the virtual object, creating a target virtual image, and switching presenting of the second page content to presenting of the first page content, an initial growth value of the target virtual image is determined based on a presenting duration of a preset relationship identifier between the current user and the target user.

According to one or more embodiments of the present disclosure, in the method of example 18 according to example 17, the first page content includes an object identifier of the virtual object, and switching presenting of the second page content to presenting of the first page content includes:

switching the preset relationship identifier presented in the conversation interface to an object identifier of the virtual object.

According to one or more embodiments of the present disclosure, in the method of example 19 according to example 18, the presenting style of the object identifier switched to is associated with the presenting style of the preset relationship identifier and/or the initial growth value.

According to one or more embodiments of the present disclosure, in the method of example 20 according to examples 1-8, further including:

in response to achieving second co-raise achievement for the virtual object, adding a conversation tool corresponding to the second co-raise achievement to a conversation tool interface of the current user, the conversation tool including at least one of a message display theme style, a conversation gadget, and a conversation emoji.

According to one or more embodiments of the present disclosure, Example 21 provides an apparatus for presenting a conversation interface, including:

an operation receiving module configured to receive a conversation interface presenting operation of a current user for a target user;

a conversation interface presenting module configured to show a conversation interface between the current user and the target user in response to the conversation interface presenting operation; and

a content presenting module configured to show page content corresponding to a virtual object in the conversation interface, the virtual object associated with interaction behavior information between the current user and the target user.

According to one or more embodiments of the present disclosure, Example 22 provides an electronic device, including:

one or more processors;

a memory configured to store one or more programs,

the one or more programs, when executed by the one or more processors, cause the one or more processors to implement the method for presenting a conversation interface according to any one of examples 1-20.

According to one or more embodiments of the present disclosure, Example 23 provides a computer readable storage medium having stored thereon a computer program that, when executed by a processor, implements the method for presenting a conversation interface as described in any one of Examples 1-20.

According to one or more embodiments of the present disclosure, Example 24 provides a computer program product which, when executed by a computer, causes the computer to implement the method for presenting a conversation interface as described in any one of Examples 1-20.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order presented or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/we claim:

1. A method for presenting a conversation interface, comprising:
presenting, in response to a conversation interface presenting operation, a conversation interface between a first user and a second user;
obtaining a page content corresponding to a virtual object, the virtual object associated with information of interaction behavior between the first user and the second user; and
presenting the page content in the conversation interface.

2. The method of claim 1, wherein the virtual object being associated with first information of interaction behavior between the first user and the second user comprises:
the virtual object having an association with an relationship identifier of an interaction relationship between the first user and the second user, and the interaction relationship built based on the information of interaction behavior between the first user and the second user.

3. The method of claim 2, wherein the virtual object having the association with the relationship identifier of the interaction relationship between the first user and the second user comprising at least one of:
a growth attribute of the virtual object associated with a presentation attribute of the relationship identifier;
an object state of the virtual object associated with the relationship identifier;
display of an object identifier of the virtual object and display of the preset relationship identifier capable of switching to each other.

4. The method of claim 3, wherein the object state comprises at least one of an object color, an object look, and an object action.

5. The method of claim 1, wherein the page content comprises at least one of an object identifier of the virtual object, a page gadget corresponding to the virtual object, and a preset control corresponding to the virtual object.

6. The method of claim 5, further comprising at least one of:
presenting the object identifier in a top area of the conversation interface;
presenting the page gadget in a boundary area of the conversation interface;
presenting the preset control in an area associated with an information input area of the conversation interface.

7. The method of claim 5, wherein the page gadget is presented in a boundary area of the conversation interface, and the method further comprises, after presenting the page content corresponding to the virtual object in the conversation interface:
in response to a dragging operation on the page gadget, moving the page gadget based on the dragging operation;
in response to a completion of the dragging operation, determining a target boundary area corresponding to a current position of the page gadget, and moving the page gadget to the target boundary area for presenting;
or
adjusting a presenting position of the page gadget in the boundary area based on a presenting position of additional content to be present in the conversation interface.

8. The method of claim 1, wherein presenting the page content in the conversation interface comprises:
in response that there is a virtual object interacted cooperatively by the first user and the second user, presenting a first page content corresponding to the virtual object in the conversation interface; and/or
in response that there is no virtual object interacted cooperatively by the first user and the second user, presenting a second page content corresponding to the virtual object in the conversation interface.

9. The method of claim 8, wherein the method further comprises, after presenting the first page content in the conversation interface:
in response to receiving an object detail presenting operation in the conversation interface, presenting an object detail interface of the virtual object, wherein the object detail presenting operation comprises a triggering of the first page content.

10. The method of claim 9, wherein the method further comprises, after presenting the object detail interface of the virtual object:
in response to receiving an information modifying operation in the object detail interface, modifying object information of the virtual object; and/or
in response to receiving an achievement detail presenting operation in the object detail interface, presenting an achievement detail interface for a first interaction achievement, the first interaction achievement obtained by obtaining a virtual object interacted in cooperation with the second user.

11. The method of claim 10, wherein the object detail interface is presented with an achievement identifier for the first interaction achievement, and the achievement identifier is configured to trigger the achievement detail presenting operation;
or
the method further comprising, after presenting the achievement detail interface for the first interaction achievement:
in response to receiving a media content generating operation in the achievement detail interface, generating a media content associated with the first interaction achievement.

12. The method of claim 8, wherein presenting the second page content corresponding to the virtual object in the conversation interface in response that there is no virtual object interacted cooperatively by the first user and the second user comprises:
in response that there is no virtual object interacted cooperatively by the first user and the second user and there is a preset interaction relationship between the first user and the second user, presenting the second page content corresponding to the virtual object in the conversation interface.

13. The method of claim 8, wherein the method further comprises, after presenting the second page content corresponding to the virtual object in the conversation interface:
in response to an invitation operation in the conversation interface, presenting a invitation interface, the invitation interface configured to set object information of a virtual object to be interacted in cooperation with the second user; and
in response to a confirmation operation within the invitation interface, transmitting, in the conversation interface, invitation information for the virtual object in a form of conversation information, the invitation information enabling triggering an acceptance of the invitation for the virtual object.

14. The method of claim 13, wherein the invitation operation comprises a triggering of the second page content.

15. The method of claim 8, wherein the method further comprises, after presenting the second page content corresponding to the virtual object in the conversation interface:
in response to the second user or the first user accepting a joint interaction invitation for the virtual object, creating a virtual visual presentation of the virtual object, and switching presenting the second page content to presenting the first page content, an initial growth attribute of the virtual visual presentation determined based on a presenting duration of a preset relationship identifier between the first user and the second user.

16. The method of claim 15, wherein the first page content comprises an object identifier of the virtual object, and switching presenting the second page content to presenting the first page content comprises:
switching the preset relationship identifier presented in the conversation interface to an object identifier of the virtual object.

17. The method of claim 16, wherein a presenting style of the object identifier switched to is associated with a presenting style of the preset relationship identifier and/or the initial growth attribute.

18. The method of claim 1, further comprising:
in response to achieving a second interaction achievement for the virtual object, adding a conversation tool corresponding to the second interaction achievement to a conversation tool interface of the first user, the conversation tool comprising at least one of a message display theme style, a conversation gadget, and a conversation emoji.

19. An electronic device, comprising:
at least one processor; and
a memory communicatively connected to the at least one processor, wherein
the memory stores a computer program executable by the at least one processor, and the computer program is executed by the at least one processor to cause the at least one processor to implement a method for presenting a conversation interface, comprising:
presenting, in response to a conversation interface presenting operation, a conversation interface between a first user and a second user;
obtaining a page content corresponding to a virtual object, the virtual object associated with information of interaction behavior between the first user and the second user; and
presenting the page content in the conversation interface.

20. A non-transitory computer-readable storage medium, wherein the computer-readable storage medium stores computer instructions, and the computer instructions are configured to cause a processor to implement a method for presenting a conversation interface, comprising:
presenting, in response to a conversation interface presenting operation, a conversation interface between a first user and a second user;
obtaining a page content corresponding to a virtual object, the virtual object associated with information of interaction behavior between the first user and the second user; and
presenting the page content in the conversation interface.
